(19) United States
(12) Patent Application Publication
(10) Pub. No.: US 2022/0025696 A1
(43) Pub. Date: Jan. 27, 2022

(54) FAÇADE GLAZING AND INSULATING GLAZING UNIT

(71) Applicant: SAINT-GOBAIN GLASS FRANCE, COURBEVOIE (FR)

(72) Inventors: Alicia DRÖGE, HERZOGENRATH (DE); Thomas HOLTSTIEGE, SCHWELM (DE); Christopher MARJAN, AACHEN (DE); Christian EFFERTZ, AACHEN (DE)

(21) Appl. No.: 17/296,804

(22) PCT Filed: Jan. 21, 2020
(86) PCT No.: PCT/EP2020/051340

§ 371 Date: May 25, 2021

(51) Int. Cl. E06B 3/58; E06B 3/26; E06B 3/663; E06B 3/54; H01Q 1/22; G06K 19/077

(52) U.S. Cl. CPC E06B 3/5821; E06B 3/26; E06B 3/66314; E06B 3/6733; H01Q 1/2283; G06K 19/07786; E06B 3/5409

(57) ABSTRACT

A façade glazing with a metal frame and an insulating glazing unit inserted into the frame, which unit has at least two glass panes and a spacer and sealing profile extending circumferentially therebetween close to their edges, wherein at least one RFID transponder is attached to the insulating glazing unit as an identification element and wherein the frame engages around the edges of the insulating glazing unit and, at the same time, covers the at least one RFID transponder in the through-vision direction (arrow A) through the glass panes, wherein at least one separate metal coupling element is inserted into the frame adjacent the transponder for coupling out and coupling in HF radiation transmitted via the transponder to the outside of the façade glazing and received from the outside.

The invention relates to a façade glazing with a metal frame and an insulating glazing unit inserted into the frame, which unit has at least two glass panes and a spacer and sealing profile extending circumferentially therebetween close to their edges, wherein at least one RFID transponder is attached to the insulating glazing unit as an identification element, and wherein the frame engages around the edges of the insulating glazing unit and, at the same time, covers the transponder(s).

Modem windows, doors, and façade glazings, at least for use in northern and temperate latitudes, are usually produced using prefabricated insulating glazing units (IGUs) that have the aforementioned structure, but, optionally, can include even more than two glass panes in the combination. Such insulating glazing units are mass-produced, shipped, and also independently marketed products that should be uniquely identifiable on their way to an end product and possibly even during maintenance and servicing.

It is already known to provide insulating glazing units with identifying markings, and certain requirements of manufacturers and users have arisen in the related practice:
The identifying marking should not be visible either from the inside or from the outside of the finished window, door, or façade.
The marking should be “readable” from a distance between 30 cm and 1 m, preferably from a distance of at least 50 cm.
The marking should be as forgery-proof as possible, i.e., should not be readily possible to overwrite or to copy.

The effectiveness of conventional identifying markings, such as barcodes or QR codes, is based on their visibility, which means at least one restriction under the first aspect above. Meeting the second requirement is also difficult. Protection against copying cannot be guaranteed since barcodes and QR codes can be photographed.

It has also been proposed to provide insulating glazing units with “electronic” identifiers, in particular via radio readable identifiers, so-called “RFID transponders”. Such insulating glazing units are, for example, disclosed in WO 00/36261 A1 or WO 2007/137719 A1.

Such an RFID transponder can be protected with a password such that it cannot be overwritten or its radio capability destroyed without considerable effort.

Certain types of window and doorframes, but especially façade constructions in which insulating glazing units are installed are made predominately or at least partially of a metal (aluminum, steel . . . ), which interrupts or at least greatly attenuates the passage of radio waves from or to the RFID transponder on the insulating glazing unit. Such a prior art frame is described, for example, in DE 198 14 620 A1.

For this reason, meeting the second requirement above has, in particular, proved difficult. Known insulating glazing units provided with RFID transponders are, consequently, not readily usable with metal frame constructions. This reduces the potential range of application of glazing units identified in this manner and thus the acceptance of these marking solutions by manufacturers and users.

The object of the invention is, consequently, to provide an improved glazing solution for frame constructions made at least to a considerable extent of a metal and that also ensures meeting the aforementioned requirements in such installation situations.

This object is accomplished according to a first aspect of the invention by a façade glazing with the features of claim 1. According to the further aspect of the invention, it is accomplished by an insulating glazing unit with the features of claim 11. Expedient further developments of the idea of the invention are the subject matter of the respective dependent claims.

The invention includes the idea of taking into account the fundamentally unfavorable outgoing and incoming radiation conditions for radio waves in a metal frame of a façade glazing by means of special decoupling. It further includes the idea of installing a metal coupling element that is provided separately from the transponder in the frame in such a way that it causes decoupling of HF radiation transmitted via the antenna of the transponder toward the outside of the window, door, or façade glazing and also of incident HF radiation to the antenna.

The invention is a result of extensive experimental investigations undertaken on glazings with the aforementioned basic structure, wherein, in particular, the spacer is a desiccant-filled hollow profile that is made of metal or is coated at least in sections with a metal foil or metallized foil, and wherein a (likewise circumferential) sealant strip is applied on the pane outer surface of the spacer profile. With regard to the application situation, the inventors carried out, in particular, investigations on insulating glazing units embedded in metal frames, wherein the insulating glazing units rest on metal support elements with plastic intermediate layers and elastomer sealing strips are arranged between the outer sides of the glass panes and the inner sides of the adjacent upright frame elements. Commercially available RFID transponders, whose structure and functionality are well known and, consequently, need not be further described here, were used in the investigations. The radio wavelengths used in such transponder systems are usually in the ranges 125 kHz to 132 kHz, 13.45 MHz and 860 MHz to 960 MHz (rarely at 2.45 GHz and 5.8 GHz) and penetrate both wood and conventional plastics but not metals. The findings of the inventors apply in principle to both passive and active RFID transponders.

With regard to metal frames that engage around an insulating glazing unit and that, based on elementary laws of physics and according to the knowledge of the person skilled in the art based thereon, should sensitively interfere with, if not completely suppress, the HF radiation of RFID transponders placed near the edge or their antennas, the proposed solution is surprising. It yields the unforeseen advantage that an RFID transponder placed according to the invention can still be read out without problems and reliably at a relatively large distance of approx. 1 m from a window, a door, or a façade glazing in which the insulating glazing unit is installed.

With regard to the geometric design and placement of the metal coupling element, as well as the transponder itself, the boundary conditions imposed by the construction of the façade glazing must be taken into account. Here, the person skilled in the art can, by simple experiments, find designs and positions with advantageous transmission and reception properties. The exemplary embodiments and aspects mentioned in the following are consequently primarily recommendations for the person skilled in the art, without restricting the implementation possibilities of the invention.

In an advantageous embodiment, the transponders and the metal coupling of the or at least one transponder placed adjacent thereto can be arranged at or near a corner of the insulating glazing unit.

In light of the fact that insulating glazing units provided with transponders can sometimes be installed in multiple possible positions in a surrounding construction and that the identification in the installed state should be quick and possible from relatively great distances, it is possible, in one design of this embodiment to arrange a transponder with an associated antenna and a metal coupling element placed adjacent thereto at or near multiple corners of the insulating glazing unit. The reading device can then be held at any corner of the frame and quickly “finds” a transponder. This increases user acceptance such that the somewhat higher manufacturing cost can be accepted if necessary.

Also significant is an embodiment in which at least two metal coupling elements are arranged in a frame such that the insulating glazing unit rests on them, as a result of which they serve, at the same time, as insulating glazing support elements. Especially in this case, a composite structure of the support elements consisting of a plastic part and a metal part can be advantageous.

With regard to the embodiment of the coupling, configurations in which the metal coupling element is designed strip-shaped or as an elongated L profile are advantageous. These shapes can be readily embedded in the insulating glazing unit or placed separately therefrom in the frame of a façade structure and, moreover, they can be produced simply and economically. Important here is the relative position of the metal coupling element with respect to the RFID transponder of the insulating glazing unit, as will be explained in the following, since this results in a particularly good electromagnetic coupling of the coupling elements to the RFID signal.

Here, the term “electromagnetically coupled” means that the coupling element and the RFID transponder are coupled by an electromagnetic field, i.e., are connected both capacitively and inductively and preferably not galvanically.

With regard to the material, it is preferable for the metal coupling element to be made of copper or aluminum or an aluminum alloy or stainless steel. It goes without saying that, in principle, any metal with sufficient stability and electrical conductivity can be used. Even composite elements, e.g., made up of a metal carrier and a plastic overlay or coating, are advantageous, in particular with a view to low costs and avoiding damage during glazing assembly.

The dimensions of the metal coupling element depend, in particular, on the operating frequency of the RFID transponder.

For RFID transponders in the UHF range, in particular for RFID transponders at 865-869 MHz (including the European frequencies) or 902-928 MHz (US and other frequency bands), particularly good results were obtained for coupling elements with a length L of more than 7 cm, preferably of more than 10 cm, and in particular of more than 14 cm. The maximum length was less critical. Thus, maximum lengths of 30 cm still yielded good results and good reading ranges.

In an alternative advantageous embodiment of an insulating glazing unit according to the invention, the metal coupling element has a length L parallel to the dipole antenna of the RFID transponder from 7 cm to 40 cm, preferably from 10 cm to 20 cm, and in particular from 12 cm to 16 cm.

The width of the coupling element depends essentially on the width of the end face of the insulating glazing unit and the respective distance from the snapping into the frame. Typical widths are from 2 cm to 10 cm and preferably from 3 cm to 5 cm.

The specific dimensioning will be carried out by the person skilled in the art under consideration of the dimensions of the insulating glazing unit, on the one hand, and of the surrounding frame, on the other, in particular taking into account the width of the frame and the covering of the pane edge region by the upright frame cover.

Investigations by the inventors have shown that the reinforcement is advantageously placed at a distance in the range between 1 mm and 10 mm, in particular between 3 mm and 8 mm, from the transponder. However, under special conditions, even greater distances can still yield significantly increased readout distances for the transponder.

Furthermore, the metal coupling element must have a galvanic or at least capacitive contact with the façade frame. For this purpose, the metal coupling element is preferably firmly snapped or clamped in a holding element of the frame. It is advantageous for the metal coupling element to contact the holding element over its entire length.

With regard to the position of the metal coupling element relative to the RFID transponder, it can be deduced from investigations by the inventors that a certain offset between the transponder, which usually has an elongated structure similar to the proposed metal coupling, and the coupling element in the longitudinal direction is advantageous for the desired increase in the readout distance. The greatest amplification effect can be obtained when the edge of the coupling element is arranged such that it is arranged below the center of the transponder, with the center of the transponder indicated by the center of its dipole antenna.

An offset of V=0 is optimal. However, it was still possible to achieve good results and reading ranges with deviations therefrom. In an advantageous embodiment of the invention, the offset V at an operating frequency of the RFID transponder in the UHF range is −30 mm to +30 mm, preferably from −20 mm to +20 mm, and in particular from −10 mm to +10 mm.

In the context of the invention, it is therefore important for the metal coupling element to be placed at a defined point in the frame relative to the transponder in order to be able to fulfill its effect relative to the transponder, which is likewise positioned at a fixed position on the insulating glazing unit.

Furthermore, the design is not limited to metal coupling elements where the metal coupling element is attached (in the assembly position) in the lower frame section where it can act at the same time as a support element of the insulating glazing unit. Instead, the metal coupling element can also be placed in the upper or at least one lateral frame section.

There are various options for the placement of the transponder in the insulating glazing unit from which the person skilled in the art can select a suitable one, taking into account the specific mounting technology of the insulating glazing unit and also with respect to the specific façade or window construction. In certain embodiments, the transponder, to which a metal coupling element is assigned, is placed on the inner or outer surface of the spacer profile. In an alternative embodiment, the transponder, to which a metal coupling element is assigned, is placed on an outer surface of one of the glass panes at or near its boundary edge.

A particular advantage is the use of a metal coupling element in the form of an insulating glazing support element common in façade construction, which, by suitable positioning relative to an RFID transponder, couples its signals into and out of an adjacent metal body (e.g., the holding device) and thus multiplies the reading range of the RFID transponder.

The concept according to the invention is not restricted to façade glazings, but can also be used in windows, doors, or interior partitions with the same or a similar construction.

Advantages and functionalities of the invention are also evident from the following description of exemplary embodiments and aspects of the invention with reference to the figures. They depict:

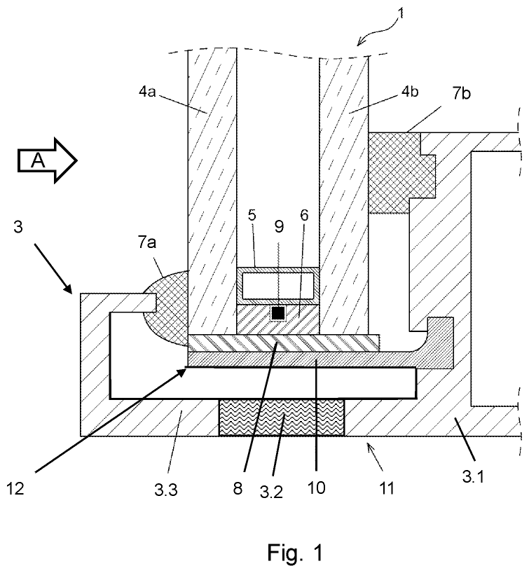

FIG. 1 a schematic representation (cross-sectional view) of an edge region of a façade glazing according to the invention,

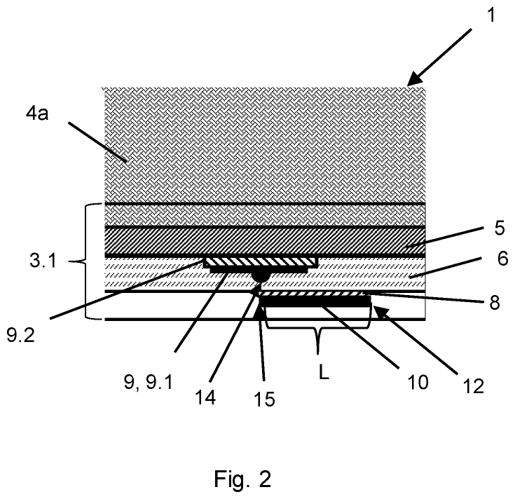

FIG. 2 a schematic representation (plan view) of the edge region of FIG. 1, and

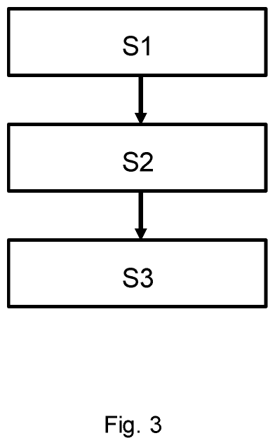

FIG. 3 a flow chart of a method according to the invention.

In the figures and the following description, the insulating glazing unit as well as the façade glazing and the individual components are in each case identified with the same or similar reference numbers, regardless of the fact that the specific embodiments differ.

FIG. 1 depicts, in a cross-sectional view, a section of a façade glazing 11 in which an insulating glazing unit 1 is inserted into a façade frame profile 3.

In this embodiment, the insulating glazing unit 1 comprises two glass panes 4a and 4b that are held apart at a predetermined distance by a spacer profile 5 placed between the glass panes 4a, 4b near the end face of the insulating glazing unit 1. The spacer profile 5 is usually hollow and filled with a desiccant (not shown) that, via small openings on the interior-side (also not shown), binds any moisture that has penetrated into the interpane space. The interpane space between the glass panes 4a and 4b is evacuated or filled with a noble gas, such as argon.

An elastomer seal (sealing profile) 6 is introduced in the edge region of the insulating glazing unit 1, between the glass panes 4a and 4b and outside the spacer profile 5. This is shown here simplified as one piece. In practice, it customarily comprises two components, one of which seals between the spacer and the glass and the other additionally stabilizes the insulating glazing unit.

Here, the insulating glazing unit 1 includes an RFID transponder 9 that is attached, for example, to the outer side of the spacer profile 5. It goes without saying that the RFID transponder can also be arranged on the glass panes 4a, 4b or in the middle of the sealing profile 6.

The frame 3 of the façade device includes a holding device 3.1, which is, for example, fixedly arranged on a building wall (not shown); further, a frame cover 3.3, which is attached to the holding device 3.1 via a polymeric and electrically insulating connecting element 3.2.

The insulating glazing unit 1 rests on at least one insulating glazing support element 12. The insulating glazing support element 12 includes a metal coupling element 10 that supports the glass panes 4a, 4b. Arranged between the metal coupling element 10 and the glass panes 4a, 4b is a plastic intermediate layer 8 that prevents damage to the glass panes 4a, 4b by direct contact with the metal of the coupling element 10.

The metal coupling element 10 has a nearly L-shaped cross-section and is snapped on one side into the holding device 3.1 and is thus electrically conductively connected to the metal of the holding device 3.1.

Furthermore, arranged between the frame 3 and the glass panes 4a, 4b are two elastomer profiles 7a, 7b that clamp the glass panes 4a, 4b in the frame 3.

FIG. 2 shows a simplified representation indicating the position of the metal coupling element 10 relative to the RFID transponder 9. FIG. 2 depicts a plan view in the viewing direction of the arrow A of or through the first glass pane 4a.

The RFID transponder 9 includes, in this exemplary embodiment, a dipole antenna 9.1, which is arranged on a dielectric carrier element 9.2. Such RFID transponders 9 are commercially available and can be used both on electrically insulating substrates and on electrically conductive substrates (for example, in the case of a metallized insulation film on the spacer 5).

In this embodiment, the insulating glazing support element 12 is placed with the metal coupling element such that an edge 15 of the metal coupling element 10 is arranged roughly below the center 14 of the dipole antenna 9.1 of the RFID transponder 9.

The metal coupling element is therefore under exactly one antenna pole of the dipole antenna 9.1 and, due to the small distance, capacitively coupled thereto. The mechanical contact of the metal coupling element 10 with the metal holding device 3.1 yields, for example, galvanic coupling. It goes without saying that at the usual operating frequencies of RFID transponders, capacitive coupling of the metal coupling element 10 to the holding device 3.1 would also suffice.

All of this results in an improved coupling and decoupling of the RFID signal and in a considerably greater readout range of the RFID signal outside the glazing. This was unexpected and surprising for the inventors.

Precise positioning of the edge 15 below the center 14 of the dipole antenna 9.1 yields the greatest reading ranges of up to 2 m distance (measured with a handheld RFID readout device). Nevertheless, an offset between the edge 15 and the center 14 of, for example, up to 30 mm yields a significant improvement in the reading ranges.

The length L of the metal coupling element 10, i.e., the dimension parallel to the pane edge or to the direction of extension of the dipole antenna 9.1 of the RFID transponder 9 is, for example, 15 cm, for an RFID transponder in the UHF range with an operating frequency of 866.6 MHz.

FIG. 3 depicts the steps of a method of production according to the invention fora façade glazing 11 according to the invention, wherein

S1) a metal holding device 3.1 is provided and is arranged, in particular, on a façade,
S2) an insulating glazing support element 12 with a metal coupling element 10 is snapped into the holding device 3.1 and an insulating glazing unit 1 is placed on the insulating glazing support element 12,
S3) a metal frame cover 3.3 is connected to the holding device 3.3 via an electrically insulating and preferably polymeric connecting element 3.2 and thus the insulating glazing unit 1 is secured in the façade glazing 11.

Another embodiment comprises a method according to the invention, wherein the metal coupling element 10 is placed in the frame 3 in a position only partially overlapping with the transponder 9.

The embodiment of the invention is not restricted to the above-described example and highlighted aspects of the embodiments, but is also possible in a large number of modifications that are evident to the person skilled in the art from the dependent claims.

### LIST OF REFERENCE CHARACTERS

1 insulating glazing unit
3 frame, façade frame profile
3.1 holding device
3.2 connecting element
3.3 frame cover
4a, 4b glass panes
5 spacer profil
6 sealing profile of the insulating glazing unit
7a, 7b elastomer profile
8 plastic intermediate layer
9 RFID transponder
9.1 dipole antenna
9.2 carrier element
10 metal coupling element
11 façade glazing
12 insulating glazing support element
14 center of the RFID transponder 9
15 edge of the metal coupling element 12
arrow A viewing direction
L length of the metal coupling element 12

1. A façade glazing with a metal frame and an insulating glazing unit inserted into the metal frame, which insulating glazing unit includes at least two glass panes and a spacer and sealing profile extending circumferentially therebetween close to edges of the at least two glass sheets,
wherein at least one RFID transponder is attached to the insulating glazing unit as an identification element and wherein the metal frame engages around the edges of the insulating glazing unit and, at the same time, covers the at least one RFID transponder in a through-vision direction through the at least two glass panes,
wherein at least one separate metal coupling element is inserted into the metal frame adjacent the at least one RFID transponder for coupling out and coupling in HF radiation transmitted via the at least one RFID transponder to an outside of the façade glazing and received from the outside, and wherein the metal coupling element is placed in the metal frame in a position only partially overlapping with the at least one RFID transponder.

2. The façade glazing according to claim 1, wherein the metal reinforcing element and the at least one RFID transponder are arranged at or near a corner of the metal frame or of the insulating glazing unit.

3. The façade glazing according to claim 1, wherein at least two metal coupling elements are arranged in the metal frame such that the insulating glazing unit rests on the at least two metal coupling elements, as a result of which the at least two metal coupling elements serve at the same time as insulating glazing support elements.

4. The façade glazing according to claim 1, wherein the metal frame comprises a metal holding element, a metal frame cover, and a connecting element that connects the metal holding element to the metal frame cover in an electrically insulating manner, and the metal coupling element, is secured to the metal holding element.

5. The façade glazing according to claim 1, wherein the metal coupling element is designed strip-shaped or as an elongated L-profile.

6. The façade glazing according to claim 1, wherein the metal coupling element has a length greater than or equal to 7 cm.

7. The façade glazing according to claim 1, wherein the metal coupling element is made of copper, aluminum or an aluminum alloy, or stainless steel.

8. The façade glazing according claim 1, wherein the metal coupling element is placed at a distance in the range from 1 mm to 10 mm from the adjacent at least one RFID transponder.

9. The façade glazing according to claim 1, wherein the metal coupling element is inserted into the metal frame together with a shock-absorbing nonmetallic element or has an elastic covering layer.

10. The façade glazing according to claim 1, wherein the metal coupling element is glued or force-fittingly inserted into a metal holding device of the metal frame.

11. The façade glazing according to claim 1, wherein the metal coupling element is inserted into the metal frame in a position predetermined by an assembly specification.

12. The façade glazing according to claim 1, wherein one edge of the metal coupling element is arranged with an offset of at most 30 mm from a center of a dipole antenna of the at least one RFID transponder.

13. A method for producing a façade glazing according to claim 1, comprising:
S1) arranging a metal holding device on a façade,
S2) snapping an insulating glazing support element with a metal coupling element into the metal holding device and placing an insulating glazing unit on the insulating glazing support element,
S3) connecting a frame cover to the holding device via an electrically insulating connecting element and the insulating glazing unit is thereby secured in the façade glazing.

14. The method for producing a façade glazing according to claim 13, wherein the metal coupling element is placed in the metal frame in a position only partially overlapping with the at least one RFID transponder.

15. A method comprising manufacturing a window, door, or interior partition with a façade glazing according to claim 1.

16. The façade glazing according to claim 4, wherein the connecting element is a polymeric connecting element.

17. The façade glazing according to claim 6, wherein the metal coupling element has a length of 7 cm to 40 cm.

18. The façade glazing according to claim 8, wherein the metal coupling element is placed at a distance in the range from 3 mm to 8 mm from the adjacent at least one RFID transponder.

19. The façade glazing according to claim 9, wherein the shock-absorbing nonmetallic element is an elastic plastic element.

20. The façade glazing according to claim 10, wherein the metal coupling element is galvanically or capacitively connected to the metal holding device.
